(19) United States
(12) Patent Application Publication
(10) Pub. No.: US 2026/0218695 A1
(43) Pub. Date: Jul. 30, 2026

(54) CONNECTOR FOR A VACUUM PUMPING SYSTEM

(71) Applicant: Edwards Limited, Burgess Hill (GB)

(72) Inventors: Hammond Deo, Burgess Hill (GB); Stuart Martin Puttick, Burgess Hill (GB)

(21) Appl. No.: 19/144,753

(22) PCT Filed: Dec. 13, 2023
(86) PCT No.: PCT/GB2023/053206

§ 371 Date: Jun. 30, 2025

(30) Foreign Application Priority Data
Jan. 26, 2023 (GB) 2301114.1

(51) Int. Cl. F04B 39/12; F04B 37/14; F04B 39/10; F04B 41/06; F04B 49/22

(52) U.S. Cl. CPC F04B 39/123; F04B 37/14; F04B 39/10; F04B 41/06; F04B 49/22

(57) ABSTRACT

A connector for use in a vacuum pumping system, the connector comprising: a conduit comprising: a first conduit portion comprising a first opening and a second opening; a second conduit portion extending from the first conduit portion at a branching point between the first opening and the second opening, the second conduit portion comprising: a third opening at an end distal from the branching point; a first valve disposed along the first conduit portion between the branching point and the second opening; and a second valve disposed along the second conduit portion between the branching point and the third opening.

This application is a national stage entry under 35 U.S.C. § 371 of International Application No. PCT/GB 2023/053206, filed Dec. 13, 2023, which claims the benefit of GB Application No. 2301114.1, filed Jan. 26, 2023, the entire contents of each of which are incorporated herein by reference.

### TECHNICAL FIELD

The present disclosure relates to connectors for use in a vacuum pumping system, such as connectors for connecting together vacuum pumps and/or abatement apparatuses.

### BACKGROUND

Vacuum pumping and abatement systems are used in varied and different technological fields, for example semiconductor fabrication. Typically, in said systems, vacuum pumping equipment is used to pump gas (e.g. gas from an industrial process) out of a particular location, and abatement equipment is used to abate (e.g. destroy or dispose of) undesirable substances (e.g. exhaust gas) which have been produced.

In many systems, vacuum pumps may be arranged as stack, for example with booster pumps positioned above or on top of combination vacuum pumps.

### SUMMARY

It tends to be desirable to easily separate pumps from a pump stack, for example to allow for easy replacement of one of the pumps while the other remains operative in the system.

Also, it tends to be desirable to provide for a direct flow of process gas between a booster and a combination pump in the pumping stack. This tends to provide much better vacuum conductance performance compared to systems that do not provide for such direct flow.

Also, it tends to be desirable to provide manifolding across all pumping stacks.

Accordingly, there is provided an apparatus, including a connector for use between vacuum pumps, which tends provide improved conductance (by direct flow of process gas between a booster and a combination pump in the pumping stack), manifolding of all the pumping stacks, and easy separation of pumps from a pump stack inside the system.

In an aspect, there is provided a connector for use in a vacuum pumping system. The connector comprises: a conduit comprising a first conduit portion comprising a first opening and a second opening, a second conduit portion extending from the first conduit portion at a branching point between the first opening and the second opening, the second conduit portion comprising a third opening at an end distal from the branching point; a first valve disposed along the first conduit portion between the branching point and the second opening; and a second valve disposed along the second conduit portion between the branching point and the third opening.

The connector may be an interstage pump isolating device for selectively isolating a first pump from one or both of a manifold and a second pump.

The first opening may be configured to be fluidly coupled to an exhaust of a first vacuum pump. The second opening may be configured to be fluidly coupled to an inlet of a second vacuum pump. The third opening may be configured to be fluidly coupled to a manifold.

The first conduit portion may be a substantially straight conduit between the first opening and the second opening. The second conduit portion may be a substantially straight conduit between the branching point and the third opening.

In a further aspect, there is provided a pumping module comprising: a first vacuum pump; a second vacuum pump; and a connector in accordance with the preceding aspect. The first vacuum pump is coupled to the first opening. The second vacuum pump is coupled to the second opening.

The first vacuum pump may be a booster pump.

The second vacuum pump may be a combination vacuum pump.

The first and second valves may be gate valves.

In a further aspect, there is provided a pumping system comprising: a plurality of pumping modules, each pumping module in the plurality of pumping modules being in accordance the preceding aspect; and a manifold. The manifold is coupled to the third opening of each pumping module in the plurality of pumping modules.

In a further aspect, there is provided a method for operating a pumping system, the pumping system being in accordance with the preceding aspect. The method comprises: for each pumping module in the plurality of pumping modules: opening the first valve of that pumping module; and pumping, by the first and second vacuum pumps of that pumping module, fluid from the first vacuum pump to the second vacuum pump via the first conduit portion.

The method may further comprise, for a first pumping module of the plurality of pumping modules: closing the first valve of the first pumping module, thereby to isolate the second vacuum pump of the first pumping module; and opening the second valve of the first pumping module.

The method may further comprise, for at least one pumping module of the plurality of pumping modules other than the first pumping module, opening the second valve of that pumping module, such that the at least one pumping module of the plurality of pumping modules takes the pumping load of the second vacuum pump of the first pumping module.

The method may further comprise, after isolating the second vacuum pump of the first pumping module, performing a servicing operation on the second vacuum pump of the first pumping module.

The method may further comprise, for a first pumping module of the plurality of pumping modules: closing the second valve of the first pumping module, thereby to isolate the first vacuum pump, the second vacuum pump, and the first valve of the first pumping module from the remainder of the pumping system. The method may further comprise, after isolating the first vacuum pump, the second vacuum pump, and the first valve of the first pumping module from the remainder of the pumping system, performing a servicing operation on one or more of the first vacuum pump, the second vacuum pump, or the first valve of the first pumping module.

The method may further comprise, for a first pumping module of the plurality of pumping modules: closing the second valve of each pumping module of the plurality of pumping modules other than the first pumping module, thereby to isolate each pumping module of the plurality of pumping modules other than the first pumping module from the manifold. The method may further comprise, after isolating each pumping module of the plurality of pumping modules other than the first pumping module from the manifold: performing a servicing operation on one or more of the first vacuum pump, the second vacuum pump, the connector, the first valve, and/or the second valve of the first pumping module; and/or performing a servicing operation on the manifold.

### BRIEF DESCRIPTION OF DRAWINGS

FIG. 1 is a schematic illustration (not to scale) showing a vacuum pumping and/or abatement system.

FIG. 2 is a schematic illustration (not to scale) showing a perspective view of a pumping module of the vacuum pumping and/or abatement system.

FIG. 3 is a schematic illustration (not to scale) showing a connector of the pumping module.

FIG. 4 is process flow chart showing certain steps of a method corresponding to a first mode of operation of the vacuum pumping and/or abatement apparatus.

FIG. 5 is a schematic illustration (not to scale) showing a gas flow path through the connector during the first mode of operation.

FIG. 6 is process flow chart showing certain steps of a method corresponding to a second mode of operation of the vacuum pumping and/or abatement apparatus.

FIG. 7 is a schematic illustration (not to scale) showing a gas flow path through the connector during the second mode of operation.

FIG. 8 is process flow chart showing certain steps of a method corresponding to a third mode of operation of the vacuum pumping and/or abatement apparatus.

FIG. 9 is process flow chart showing certain steps of a method corresponding to a fourth mode of operation of the vacuum pumping and/or abatement apparatus.

### DETAILED DESCRIPTION

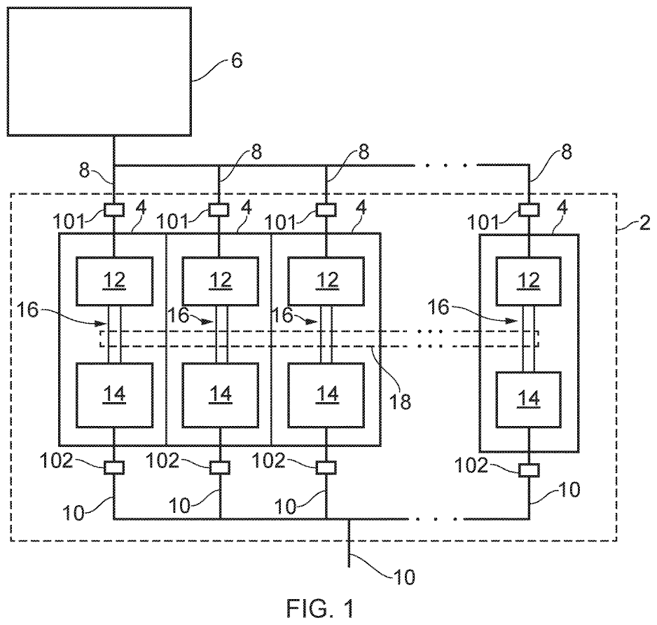

FIG. 1 is a schematic illustration (not to scale) showing a vacuum pumping system 2.

The system 2 comprises a plurality of pumping modules 4, which may also be referred to as “units” or “slices”. Each of the pumping modules 4 is fluidly connected to an entity 6 via a respective fluid input line 8, commonly referred to as a “foreline”. The entity 6 may, for example, be a chamber or room used in an industrial process such as semiconductor fabrication. Each pumping module 4 is also fluidly connected to a respective exhaust line 10.

The system comprises a plurality of valves 101, 102, e.g. gate valves, located on the fluid input lines 8 and the exhaust lines 10. The valves 101 located along the fluid input lines 8, i.e. upstream of the pumping modules 4, are hereafter referred to as “input line valves”. The valves 102 located along the exhaust lines 10, i.e. downstream of the pumping modules 4, are hereafter referred to as “exhaust line valves”. More specifically, in this embodiment, for each pumping module 4, there is a respective input line valve 101 located along the fluid input line 8 of that pumping module 4, and also a respective exhaust line valve 102 located along the exhaust line 10 of that pumping module 4. Thus, each pumping module 4 is disposed between a respective pair of upstream and downstream valves 101, 102.

Each of the pumping modules 4 comprises a respective first pump 12, a second pump 14, and a connector 16 connecting together the first pump 12 and the second pump 14.

The first and second pumps 12, 14 are vacuum pumps for pumping gas out of the entity 6. More specifically, in this embodiment, each of the first pumps 12 is a booster pump. In this embodiment, each of the second pumps 14 is a combination pump, which may be a combination of a semiconductor dry pump and a booster pump.

For each pumping module 4, an inlet of the first pump 12 is fluidly coupled to the fluid input line 8 of that pumping module 4. An outlet of the first pump 12 is fluidly coupled to an inlet of the connector 16 of that pumping module 4. An outlet of the connector 16 is fluidly coupled to an inlet of the second pump 14 of that pumping module 4. An outlet of the second pump 14 is fluidly coupled to the exhaust line 10 of that pumping module 4.

In one mode of operation, the system 2 pumps gas out of the entity 6 via the fluid input lines 8. In particular, gas is pumped by the pumps 12, 14 of the pumping modules such that it travels from the entity 6 to the first pumps 12 via the fluid input lines 8, then through the first pumps 12, then from the first pumps 12 to the second pumps 14 via the connectors 16, then through the second pumps 14, and then from the second pumps 14 out of the system 2 via the exhaust lines 10.

In some embodiments, the system 2 abates (e.g., destroys or disposes of) undesirable substances produced by the entity 6 which may be present in the pumped gas. That is to say, the system 2 may comprise one or more abatement apparatuses for abating undesirable substances produced by the entity 6. Thus, the vacuum pumping system 2 may be a vacuum pumping and/or abatement system.

In some embodiments, the system 2 may further include additional modules or apparatuses including, but not limited to, one or more of an inverter for converting AC electrical power into AC electrical power with modified frequency, an electronic controller for controlling operation of all or part of the system 2, or a facilities apparatus for carrying out functions relating to facilities.

The vacuum pumping and/or abatement system 2 may be an integrated system. The term “integrated system” may be used to refer to two or more modules integrated together into a common system, the modules being selected from the group of modules consisting of: a module comprising vacuum pumping apparatus, a module comprising process gas abatement apparatus, and a module comprising a controller for controlling the vacuum pumping and/or abatement apparatuses.

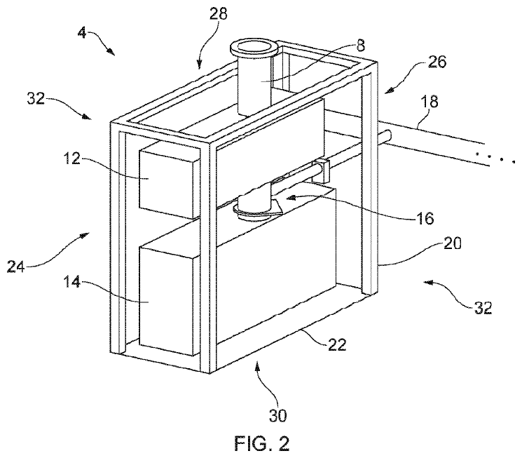

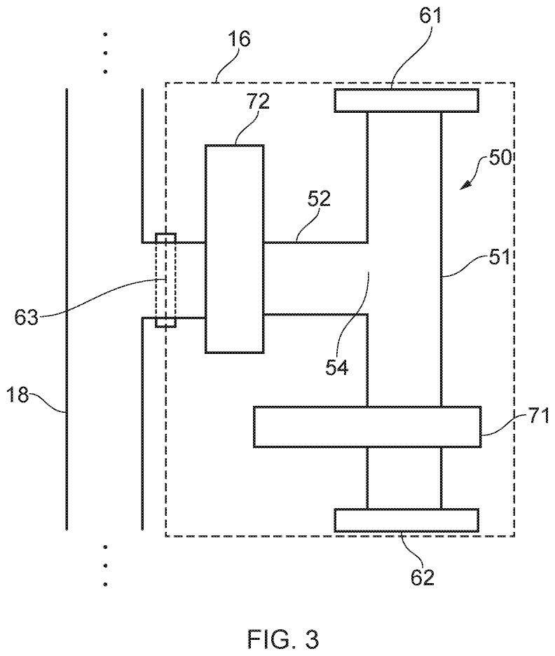

In this embodiment the pumping modules 4 are fluidly coupled together via a manifold 18. More specifically, the manifold 18 connects together the connectors 16 of the pumping modules 4 (as described in more detail later below with reference to FIGS. 2 and 3), thereby to allow for the gas to be pumped between pumping modules 4.

FIG. 2 is a schematic illustration (not to scale) showing a perspective view of a pumping module 4 of the vacuum pumping system 2.

The pumping module 4 comprises a frame 20 and a base 22 connected to the frame 20. The base 22 may be considered to be a part of the frame 20.

The frame 20 and/or base 22 may be bolted to the ground/floor.

The first pump 12, the second pump 14, and the connector 16 of the pumping module 4 are disposed within the volume defined by the frame 20 and the base 22. The frame 20 comprises a plurality of interconnected bars coupled to the base 22.

The pumping module 4 has a front side 24, a rear side 26, a top side 28, a bottom side 30, and two opposing lateral sides 32.

FIG. 3 is a schematic illustration (not to scale) of the connector 16.

In this embodiment, the connector 16 comprises a conduit 50 having a first conduit portion 51 and a second conduit portion 52.

The first conduit portion 51 comprises a first opening 61, which in this embodiment is located at a first end of the first conduit portion 51, and a second opening 62, which in this embodiment is located at a second end of the first conduit portion 51 opposite to the first end.

The second conduit portion 52 extends from the first conduit portion 51. In particular, the second conduit 52 extends from a branching point 54 on the first conduit 51. The branching point 54 is located along the first conduit 51 at an intermediate position between the first opening 61 and the second opening 62.

The second conduit portion 52 comprises a third opening 63 at an end of the second conduit portion 52 distal from the branching point 54.

The connector 16 comprises a first valve 71. The first valve 71 is disposed along (e.g., in) the first conduit portion 51 between the branching point 54 and the second opening 62. In this embodiment, the first valve 71 is a gate valve.

The connector 16 further comprises a second valve 72. The second valve 72 disposed (e.g., in) the second conduit portion 52 between the branching point 54 and the third opening 63. In this embodiment, the second valve 72 is a gate valve.

In this embodiment, when the connector 16 is installed in the system 2, as shown in FIGS. 1 and 2, the first opening 61 is fluidly coupled to an outlet or exhaust of the first vacuum pump 12. For example, the first conduit portion 51 may comprise, at its first end and circumscribing the first opening 61, a first flange that may be attached (e.g. bolted) to an outlet of the first pump 12. Also, when the connector 16 is installed in the system 2, the second opening 62 is fluidly coupled to an inlet of the second vacuum pump 14. For example, the first conduit portion 51 may comprise, at its second end and circumscribing the second opening 62, a second flange that may be attached (e.g. bolted) to an inlet of the second pump 14. Also, when the connector 16 is installed in the system 2, the third opening 63 is fluidly coupled to the manifold 18 (as shown in FIG. 3). For example, the second conduit portion 52 may comprise, at the third end and circumscribing the third opening 63, a third flange that may be attached (e.g. bolted) to a respective inlet of the manifold 18.

Preferably, the first conduit portion 51 is a substantially straight conduit between the first opening 61 and the second opening 62. This advantageously tends to provide for improved pumping efficiency compared to, for example, pumping systems having convoluted paths between successive pumps. Nevertheless, the first conduit portion 51 may be convoluted.

Preferably, the second conduit portion 52 is a substantially straight conduit between the branching point 54 and the third opening 63. This advantageously tends to provide for improved pumping efficiency compared to, for example, pumping systems having convoluted gas paths. Nevertheless, the second conduit portion 52 may be convoluted.

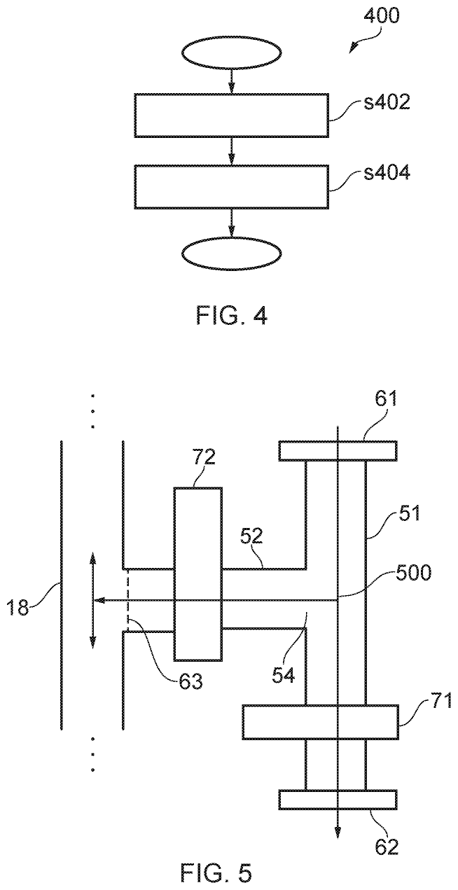

FIG. 4 is a process flow chart showing certain steps of a method 400 of operating the system 2. The process of FIG. 4 may correspond to a first mode of operation for the system 2.

At step s402, for each of the pumping modules 4, the first valve 71 of the connector 16 is opened, for example by a controller of the system 2. While the first valve 71 of each pumping module 4 is opened at step s402, the second valves 72 of each of the pumping modules 4 may also be open, thereby to provide a shared pumping arrangement.

At step s404, each of the pumping modules 4 pumps gas from the entity 6 and out of the system 2. In particular, for each of the pumping modules 4, the first and second vacuum pumps 12, 14 of that pumping module 4 pump gas from the entity 6, via a respective fluid inlet line 8, and out of the system 2, via a respective exhaust line 10. In each of the pumping modules 4, fluid is pumped from the first pump 12 directly to the second pump 14 via the first conduit portion 51 of the connector 16. The gas may be pumped between pumping module 4 via the manifold 18 and the open second valves 72. Operation of the pumps 12, 14 may be controlled by a controller of the system 2.

FIG. 5 is a schematic illustration depicting fluid flow 500 through the connectors 16 of the pumping modules during the first mode of operation (i.e. the method 500).

Thus, a first mode of operation for the system 2 is provided.

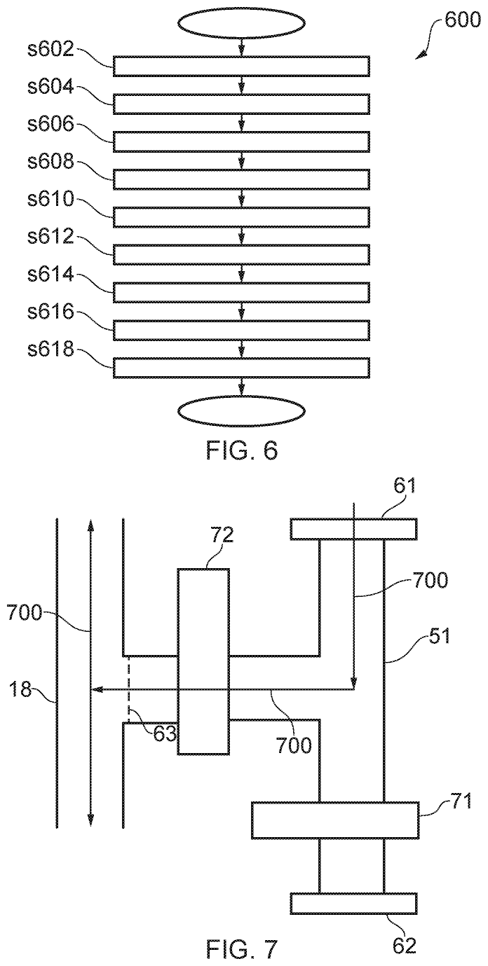

FIG. 6 is a process flow chart showing certain steps of another method 600 of operating the system 2. The process of FIG. 6 may correspond to a second mode of operation for the system 2.

At step s602, the system 2 may be operated in accordance with the first mode of operation, i.e. the method 400 described in more detail earlier above with reference to FIG. 4.

At step s604, for a first pumping module 4 of the plurality of pumping modules 4, the first valve 71 of that first pumping module 4 is closed, for example by a controller of the system 2. In other words, the pumped gas is prevented from flowing from the first pump 12 of the first pumping module 4 to the second pump 14 of the first pumping module 4 by the closed first valve 71. Furthermore, the exhaust line valve 102 in the exhaust line 10 of the first pumping module 4 may be closed, thereby to prevent a backflow of process gas towards the second vacuum pump 14 of the first pumping module 4. Thus, the second vacuum pump 14 of the first pumping module 4 is fluidly isolated from the remainder of the system 2.

At step s606, the second valve 72 of the first pumping module 4 is kept open (or opened in embodiments in which it is previously closed). A controller of the system 2 may control the second valve 72.

At step s608, the second valve 72 of at least one pumping module 4 of the plurality of pumping modules 4 other than the first pumping module 4 (and preferably all available other pumping modules 4) is kept open, for example by a controller of the system 2 (or opened in embodiments in which it is previously closed). Thus, the pumped gas flows from the first pump 12 of the first pumping module 4 into the manifold 18, through the manifold 18, and then into at least one pumping module 4 of the plurality of pumping modules 4 other than the first pumping module 4. In this way, the at least one pumping module 4 of the plurality of pumping modules 4 takes the pumping load of the second vacuum pump 14 of the first pumping module 4 that has been fluidly isolated from the rest of the system.

FIG. 7 is a schematic illustration depicting fluid flow 700 through the connector 16 of the first pumping module 4 during the second mode of operation (i.e. the method 600).

At step s610, after fluidly isolating the second vacuum pump 14 of the first pumping module 4, that isolated second vacuum pump 14 may be turned off or deactivated. The isolated second vacuum pump 14 may be decoupled from the rest of the system 2.

At step s612, after fluidly isolating the second vacuum pump 14 of the first pumping module 4, a servicing operation (such as an inspection, maintenance, cleaning, repair, and/or replacement operation) is performed on that isolated second vacuum pump 14. The servicing operation may be performed by a human operator.

At step s614, after performance of the servicing operation on the second vacuum pump 14 of the first pumping module 4, that vacuum pump 14 may be recoupled or reconnected to the system 2, i.e. to the second end of the first conduit portion 51 of the connector 16 of the first pumping module 4. Also the first pumping module 4 is reconnected to the exhaust line valve 102.

At step s616, the second vacuum pump 14 of the first pumping module 4 may be turned on or reactivated.

At step s618, the first valve 71 of the first pumping module 4 is opened, for example by a controller of the system 2. Furthermore, the exhaust line valve 102 in the exhaust line 10 of the first pumping module 4 is opened. The second valve 72 of the first pumping module 4 may be kept open, for example by a controller of the system 2. In this way, the gas is pumped through the first pumping module 4 from the first pump 12 directly to the second pump 14 via the first conduit portion 51 of the connector 16, and/or to other pumping modules 4 via the manifold 18, e.g. following the flow path 500 shown in FIG. 5.

Thus, a second mode of operation for the system 2 is provided. In the second mode of operation, servicing of a second pump 14 of a pumping module 4 may be performed, avoiding a need to shut down the pumping system 2. Further, this tends to be achieved without significant loss of pumping performance, since the pumping load of the second pump 14 of the first pumping module 4 upon which the servicing is performed may be taken up by the remainder of the pumping modules 4.

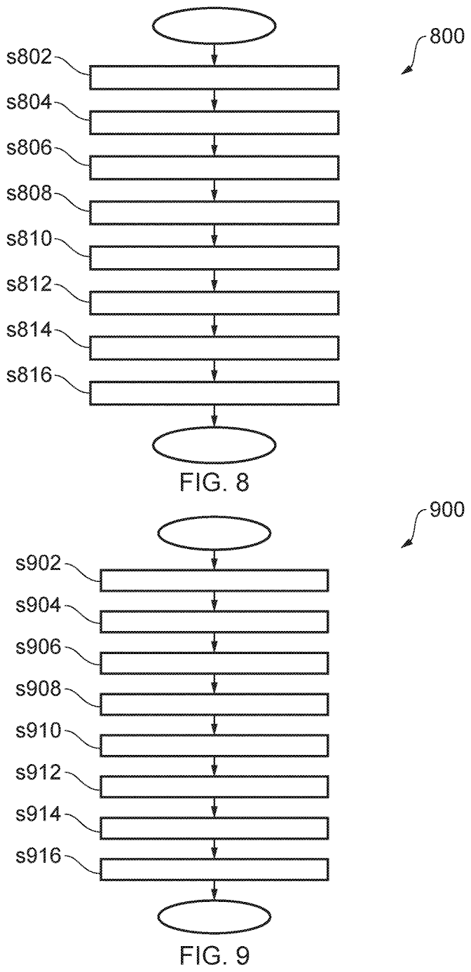

FIG. 8 is a process flow chart showing certain steps of another method 800 of operating the system 2. The process of FIG. 8 may correspond to a third mode of operation for the system 2.

At step s802, the system 2 may be operated in accordance with the first mode of operation, i.e. the method 400 described in more detail earlier above with reference to FIG. 4.

At step s804, for a first pumping module 4 of the plurality of pumping modules 4, the second valve 72 of that first pumping module 4 is closed.

At step s806, the inlet line valve 101 and the exhaust line valve 102 along the fluid inlet line 8 and the exhaust line 10, respectively, of the first pumping module 4 are closed.

In this way, the pumps 12, 14 and the first valve 71 of the connector 16 of the first pumping module 4 are fluidly isolated from the remainder of the system 2. Also, gas is prevented from flowing though the pumps 12, 14 and the first valve 71 of the connector 16 of the first pumping module 4 by the closed foreline and exhaust line valves 101, 102, and the closed second valve 72 in that connector 16.

At step s808, after fluidly isolating the pumps 12, 14 and the first valve 71 of the connector 16 of the first pumping module 4, the isolated pumps 12, 14 may be turned off or deactivated. The isolated first pump 12 and/or second pump 14 may be decoupled from the rest of the system 2.

At step s810, after fluidly isolating the pumps 12, 14 and the first valve 71 of the connector 16 of the first pumping module 4, a servicing operation (such as an inspection, maintenance, cleaning, repair, and/or replacement operation) is performed on the isolated first pump 12, second pump 14 and/or the first valve 71 of the connector 16. The servicing operation may be performed by a human operator.

At step s812, after performance of the servicing operation at step s810, the pumps 12, 14 and/or the first valve 71 of the connector 16 of the first pumping module 4 may be recoupled or reconnected to the system 2.

At step s814, the pumps 12, 14 of the first pumping module 4 may be turned on or reactivated.

At step s816, the first valve 71 of the first pumping module 4 is opened, for example by a controller of the system 2. The inlet line and exhaust line valves 101, 102 for the first pumping module 4 are also opened, for example by a controller of the system 2. The second valve 72 of the first pumping module 4 may be opened, for example by a controller of the system 2. In this way, the gas is pumped through the first pumping module 4 from the first pump 12 directly to the second pump 14 via the first conduit portion 51 of the connector 16, e.g. following the flow path 500 shown in FIG. 5.

Thus, a third mode of operation for the system 2 is provided. In the third mode of operation, servicing of a first pump 12, a second pump 14, and/or of a first valve 71 of a connector 16 of a pumping module 4 may be performed, avoiding a need to shut down the pumping system 2.

FIG. 9 is a process flow chart showing certain steps of another method 900 of operating the system 2. The process of FIG. 9 may correspond to a fourth mode of operation for the system 2.

At step s902, the system 2 may be operated in accordance with the first mode of operation, i.e. the method 400 described in more detail earlier above with reference to FIG. 4.

At step s904, for each pumping module 4 other than a first pumping module 4, the second valve 72 of that pumping module 4 is closed, for example by a controller of the system 2. In this way, each of the pumping modules 4 other than a first pumping module 4 is fluidly isolated from the manifold 18.

At step s906, the inlet line valve 101 and the exhaust line valve 102 along the fluid inlet line 8 and the exhaust line 10, respectively, of the first pumping module 4 are closed.

In this way, the first pumping module 4 and the manifold 18 are fluidly isolated from the rest of the system 2. Also, gas is prevented from flowing through the first pumping module 4 and the manifold 18.

At step s908, after isolating the first pumping module 4 and the manifold 18, those entities may be purged, for example by pumping nitrogen gas therethrough. subsequently, the pumps 12, 14 of the first pumping module 4 may be turned off or deactivated. The first pump 12, the second pump 14, the connector 16 and/or the manifold 18 may be decoupled from the rest of the system 2.

At step s910, after isolating the first pumping module 4 and the manifold 18, a servicing operation (such as an inspection, maintenance, cleaning, repair, and/or replacement operation) is performed on at least a part of the first pumping module 4 and/or the manifold 18. For example, the serving operation may be performed on the first pump 12, the second pump 14, the first valve 71 and/or the second valve 72 of the first pumping module 4. The servicing operation may be performed by a human operator.

At step s912, after performance of the servicing operation at step s910, the first pumping module 4 and the manifold 18 may be recoupled or reconnected to the system 2.

At step s914, the pumps 12, 14 of the first pumping module 4 may be turned on or reactivated.

At step s916, the first valve 71 of the first pumping module 4 is opened, for example by a controller of the system 2. The inlet line and exhaust line valves 101, 102 for the first pumping module 4 are also opened, for example by a controller of the system 2. The second valve 72 of the first pumping module 4 may also be opened, for example by a controller of the system 2. In this way, the gas is pumped through the first pumping module 4 from the first pump 12 directly to the second pump 14 via the first conduit portion 51 of the connector 16, e.g. following the flow path 500 shown in FIG. 5.

Thus, a fourth mode of operation for the system 2 is provided. In the fourth mode of operation, servicing of a first pump 12, a second pump 14, a connector 16 (e.g. of the first valve 71 and/or the second valve 72), or of the manifold 18 may be performed, avoiding a need to shut down the pumping system 2.

In many vacuum pumping systems, a vacuum pump module may comprise a booster pump and dry pump combination in a single package. For some applications, higher vacuum capability is required so a large booster can be added on top of the pump combination to create a so-called “triple stack”. The term “triple stack” is typically used to refer to a combination of two pump packages, which may comprise a first package having a booster (1 pump) and a second package having a pump combination (2 pumps). Such triple stacks tend to be difficult to service, as the pumps tend to be physically large. Additional safety measures tend to be required, and servicing tends to take considerably longer compared to servicing a single unit.

Conventional system designs address these problems by enabling pump separation inside the system, and may allow either of the pumps packages to be removed for service separately. However, in conventional systems that address these problems, there is no direct pipe between successive pumps. Vacuum pumps are typically sensitive to the natural ‘resistance’ in the pipes feeding into them; the more bends and restrictions in a pipe, the less ‘conductance’. Thus, the lack of a direct, straight pipe between successive pumps tends to adversely affect pumping performance. The connector described herein advantageously tends to provide a straight pipe, or direct, connection between successive pumps 12, 14, while also allowing for either or both pumps to be isolated and removed from the system 2. Additionally, the system described herein allows for servicing of the gate valves while the system is in operation. Conventionally, servicing of gate valves is difficult, and may require turning off the whole system.

The present inventors have realised that it tends to be the case that the pump combination is more likely to require servicing than the booster pump. The above-described apparatus tends to allow for easy isolation and removal of a pump combination (second pump) in a way that avoids having to turn off the whole system.

The above-described connector provides a direct path from the booster to the pump combination without going through the manifold. An isolation valve (the first valve) is located on top/upstream of the pump combination inlet. This tends to allow the bottom pump to be isolated easily for the most common pump service operation. This direct path of connection between pumps tends to provide for improved conductance and pump performance. The connector conduit branches between the pumps before the first valve. This branch (i.e. the second conduit portion) transitions rearwards towards the manifold that runs across the rear of the system. This branch has a gate valve (i.e. the second valve) that allows the whole triple stack to be isolated from the manifold if required. By turning off both gate valves the booster can be separated and removed independently while the rest of the system continues to operate.

Advantageously, the connector can be applied in different orientations.

In the above embodiments, the connector is implemented in a modular vacuum pumping and/or abatement system that is described in more detail earlier above with reference to FIGS. 1 and 2. The pumping modules are arranged and connected together in a side-by-side, contiguous arrangement, each pumping module being attached to one or more adjacent modules at one or both of its lateral sides. However, in other embodiments, the connector is implemented in a different type of vacuum pumping and/or abatement system, which is different to that described above.

In the above embodiments, the connector connects together two vacuum pumps, specifically a booster pump to a combination pump. However, in other embodiments, the connector is used to connect together a different pair of entities, for example to connect together two combination pumps, or a vacuum pump to an abatement apparatus.

1. A connector for use in a vacuum pumping system, the connector comprising:
a conduit comprising:
a first conduit portion comprising:
a first opening; and
a second opening;
a second conduit portion extending from the first conduit portion at a branching point between the first opening and the second opening, the second conduit portion comprising:
a third opening at an end distal from the branching point;
a first valve disposed along the first conduit portion between the branching point and the second opening; and
a second valve disposed along the second conduit portion between the branching point and the third opening.

2. The connector of claim 1, wherein:
the first opening is configured to be fluidly coupled to an exhaust of a first vacuum pump;
the second opening is configured to be fluidly coupled to an inlet of a second vacuum pump; and
the third opening is configured to be fluidly coupled to a manifold.

3. The connector of claim 1, wherein the first conduit portion is a substantially straight conduit between the first opening and the second opening.

4. The connector of claim 1, wherein the second conduit portion is a substantially straight conduit between the branching point and the third opening.

5. A pumping module comprising:
a first vacuum pump;
a second vacuum pump; and
a connector in accordance with any preceding claim; wherein
the first vacuum pump is coupled to the first opening; and
the second vacuum pump is coupled to the second opening.

6. The pumping module of claim 5, wherein
the first vacuum pump is a booster pump; and/or
the second vacuum pump is a combination vacuum pump.

7. A pumping system comprising:
a plurality of pumping modules, each pumping module in the plurality of pumping modules being in accordance with claim 5; and
a manifold; wherein
the manifold is coupled to the third opening of each pumping module in the plurality of pumping modules.

8. A method for operating a pumping system, the pumping system being in accordance with claim 7, the method comprising:
for each pumping module in the plurality of pumping modules:
opening the first valve of that pumping module; and
pumping, by the first and second vacuum pumps of that pumping module, fluid from the first vacuum pump to the second vacuum pump via the first conduit portion.

9. The method of claim 8, further comprising:
for a first pumping module of the plurality of pumping modules:
closing the first valve of the first pumping module, thereby to isolate the second vacuum pump of the first pumping module; and
opening the second valve of the first pumping module.

10. The method of claim 9, further comprising, for at least one pumping module of the plurality of pumping modules other than the first pumping module, opening the second valve of that pumping module, such that the at least one pumping module of the plurality of pumping modules takes the pumping load of the second vacuum pump of the first pumping module.

11. The method of claim further comprising, after isolating the second vacuum pump of the first pumping module, performing a servicing operation on the second vacuum pump of the first pumping module.

12. The method of claim 8, further comprising:
for a first pumping module of the plurality of pumping modules:
closing the second valve of the first pumping module, thereby to isolate the first vacuum pump, the second vacuum pump, and the first valve of the first pumping module from the remainder of the pumping system.

13. The method of claim 12, further comprising, after isolating the first vacuum pump, the second vacuum pump, and the first valve of the first pumping module from the remainder of the pumping system, performing a servicing operation on one or more of the first vacuum pump, the second vacuum pump, or the first valve of the first pumping module.

14. The method of claim 8, further comprising:
for a first pumping module of the plurality of pumping modules:
closing the second valve of each pumping module of the plurality of pumping modules other than the first pumping module, thereby to isolate each pumping module of the plurality of pumping modules other than the first pumping module from the manifold.

15. The method of claim 14, further comprising, after isolating each pumping module of the plurality of pumping modules other than the first pumping module from the manifold:
performing a servicing operation on one or more of the first vacuum pump, the second vacuum pump, the connector, the first valve, and/or the second valve of the first pumping module; and/or
performing a servicing operation on the manifold.
